(19) United States
(12) Patent Application Publication
(10) Pub. No.: US 2026/0099159 A1
(43) Pub. Date: Apr. 9, 2026

(54) SYSTEMS AND METHODS FOR PREEMPTIVE MITIGATION OF UNDESIRABLE OPERATIONS IN A FLEET OF VEHICLES

(71) Applicant: Textron Inc., Providence, RI (US)

(72) Inventors: Jonathan Daniel Bowen, North Augusta, SC (US); Russell William King, Evans, GA (US); Gregory August Theodosakis, Martinez, GA (US)

(73) Assignee: Textron Inc., Providence, RI (US)

(21) Appl. No.: 18/909,019

(22) Filed: Oct. 8, 2024

(51) Int. Cl. G05D 1/80; G05D 1/69; G05D 109/10

(52) U.S. Cl. CPC G05D 1/80; G05D 1/69; G05D 2109/10

(57) ABSTRACT

A golf vehicle fleet system for responding to undesirable operations within a fleet of golf vehicles includes one or more memory devices having instructions stored thereon that, when executed by one or more processors, cause the one or more processors to detect a risk of an undesirable operation of a golf vehicle of the plurality of golf vehicles, and transmit a command to at least the golf vehicle of the fleet of golf vehicles to implement an action to mitigate a future occurrence of the undesirable operation with the golf vehicle

### BACKGROUND

The present disclosure relates to mitigating undesirable operations in a fleet of off-road vehicles. More specifically, the present disclosure relates to propagating or transmitting commands for mitigating actions including, but not limited to, vehicle performance restrictions and user notifications to a number of vehicles after a vehicle experiences undesirable operations.

### SUMMARY

One embodiment relates to a golf vehicle fleet system for responding to undesirable operations within a fleet of golf vehicles. The golf vehicle fleet system includes one or more memory devices having instructions stored thereon that, when executed by one or more processors, cause the one or more processors to detect a risk of an undesirable operation of a golf vehicle of the plurality of golf vehicles, and transmit a command to at least the golf vehicle of the fleet of golf vehicles to implement an action to mitigate a future occurrence of the undesirable operation with the golf vehicle. In some embodiments, detecting the risk of an undesirable operation includes acquiring vehicle data regarding a second golf vehicle of a plurality of golf vehicles of the fleet of golf vehicles and detecting an occurrence of the undesirable operation of the second golf vehicle of the plurality of golf vehicles. In some embodiments, detecting the risk of an undesirable operation comprises at least one of acquiring an adverse weather forecast or acquiring information related to an event with potential for increased golf vehicle traffic.

Another embodiment relates to an off-road vehicle fleet system for responding to undesirable operations within a fleet of off-road vehicles. The fleet of off-road vehicles includes a first off-road vehicle configured to transmit vehicle data about operations thereof and a second off-road vehicle configured to receive commands to mitigate the undesirable operations. The off-road vehicle fleet system includes a non-transitory computer-readable medium having instructions stored thereon that, when executed by one or more processors, cause the one or more processors to acquire the vehicle data regarding the first off-road vehicle, detect an occurrence of an undesirable operation of the first off-road vehicle, calculate a value related to a need for the second off-road vehicle to take an action to mitigate a subsequent occurrence of the undesirable operation, and transmit a command to the second off-road vehicle to implement the action to mitigate the subsequent occurrence of the undesirable operation in response to the value satisfying a criterion. The value is calculated using a multi-dimensional function of at least a first location of the second off-road vehicle relative to a second location of the occurrence of the undesirable operation.

Still another embodiment relates to a golf vehicle fleet system for responding to undesirable operations within a fleet of golf vehicles. The golf vehicle fleet system includes a non-transitory computer-readable medium having instructions stored thereon that, when executed by one or more processors, cause the one or more processors to acquire vehicle data regarding a first golf vehicle of a plurality of golf vehicles of the fleet of golf vehicles, detect an occurrence of an undesirable operation of the first golf vehicle of the plurality of golf vehicles, and cause a second golf vehicle of the fleet of golf vehicles to implement an action to mitigate a subsequent occurrence of the undesirable operation with the second golf vehicle when the second golf vehicle is proximate a location where the undesirable operation occurred.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a schematic block diagram of a fleet performance restriction system with a number of the vehicles of FIG. 1 and a number of user devices, according to an exemplary embodiment.

FIG. 5 is an illustration of a map with a regular grid superimposed, according to an exemplary embodiment.

FIG. 6 is a perspective view of a multi-dimensional function used for calculating a value related to the need to restrict performance of a vehicle, according to an exemplary embodiment.

FIG. 7 is a contour plot of the multi-dimension function of FIG. 5 after a number of occurrences of undesirable operations overlaid on a map, according to an exemplary embodiment.

FIG. 8 is a flow diagram of a method for mitigating undesirable operations within a fleet of vehicles, according to an exemplary embodiment.

FIG. 9 is a flow diagram of additional steps of the method of FIG. 7, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

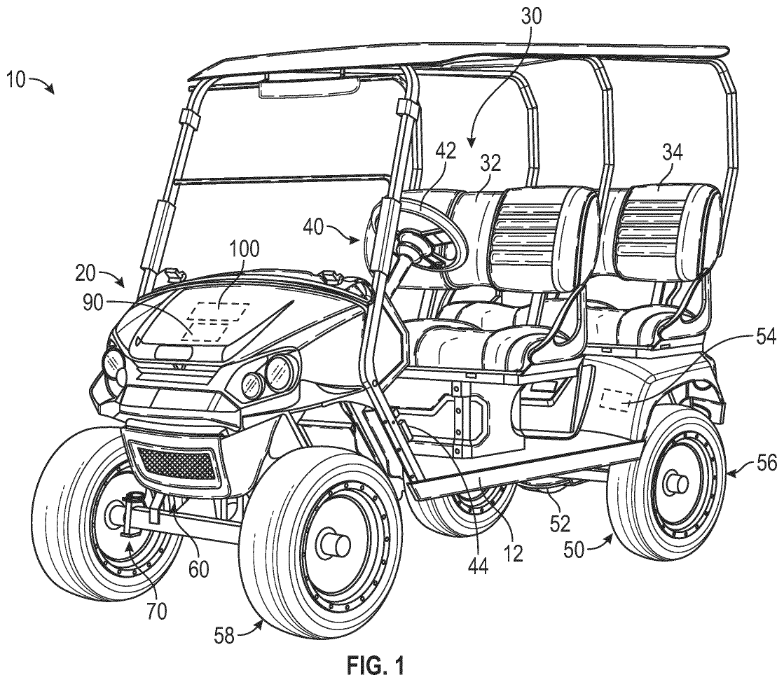

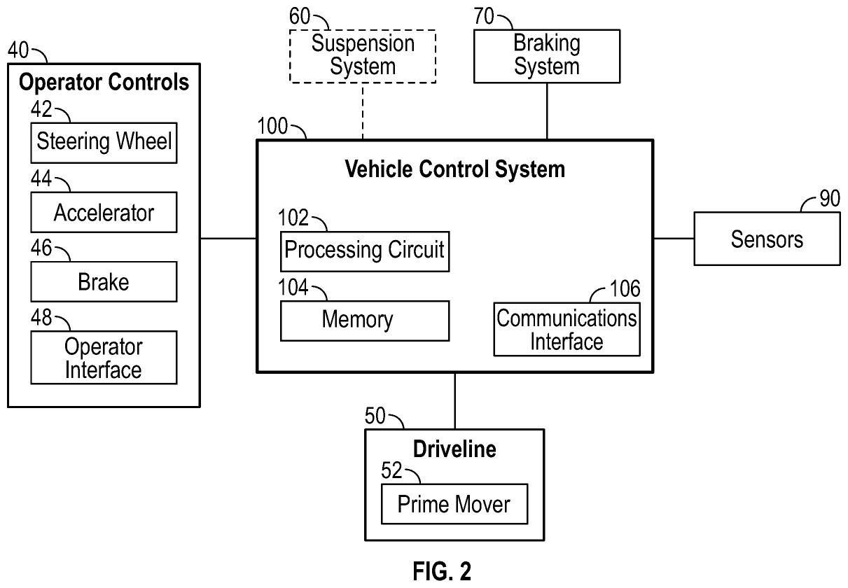

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a vehicle control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

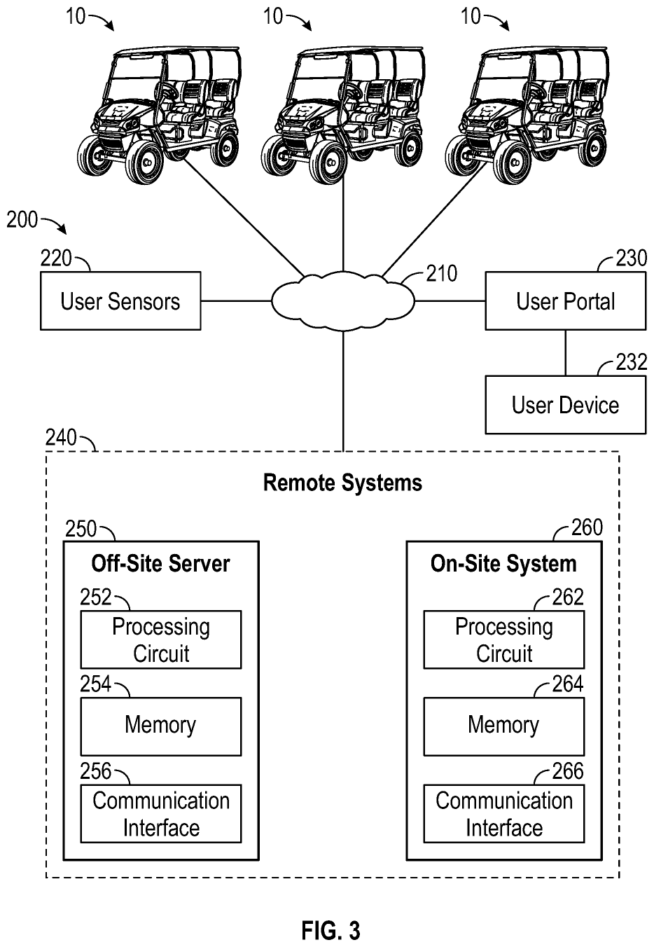

As shown in FIG. 3, a monitoring and control system, shown as site monitoring and control system 200, include one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the site monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 3, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Fleet Performance Restriction System

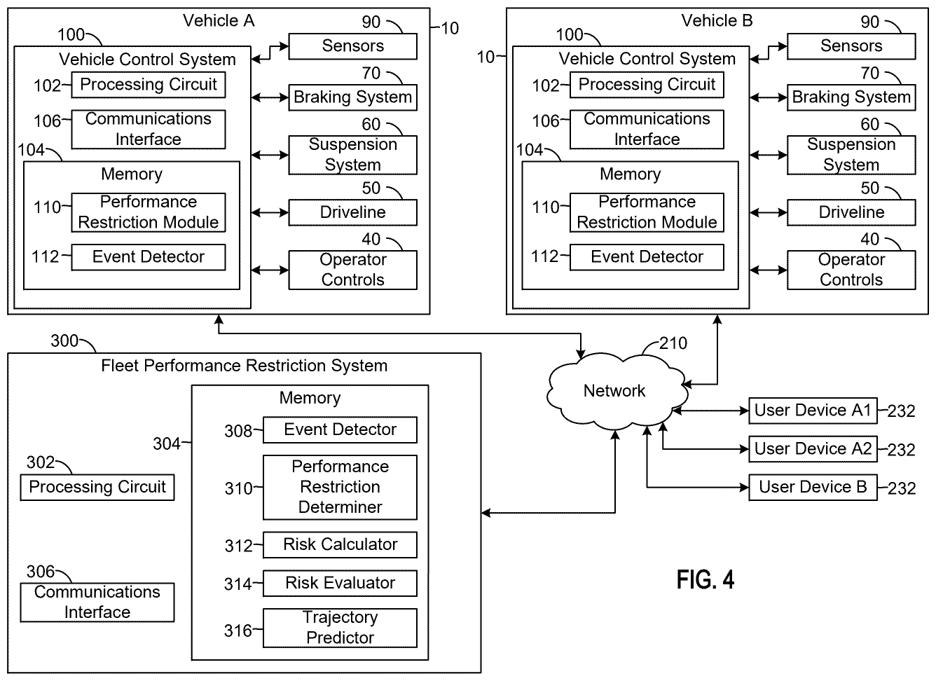

FIG. 4 shows a fleet performance restriction system 300. According to an exemplary embodiment, the fleet performance restriction system 300 is configured to mitigate the recurrence of undesirable operations within a fleet of vehicles. In some embodiments, the remote systems 240 include the fleet performance restriction system 300. By way of example, the fleet performance restriction system 300 may be or included with the off-site server 250 and/or the on-site system 260. In some embodiments, the vehicle control system 100 is configured to include the fleet performance restriction system 300. In some embodiments, any of the features, components, or instructions included in the fleet performance restriction system 300 may be distributed across the vehicle control system 100, the on-site system 260, the off-site server 250, or any off-vehicle system included in the remote systems 240.

Referring to FIG. 4, the fleet performance restriction system 300 may be communicably connected to a fleet of the vehicles 10 (including vehicle A and vehicle B) and a plurality of the user devices 232 (including user device A1, user device A2, and user device B1) via the communications network 210. As shown in FIG. 4, each of the vehicles 10 included in the fleet of vehicles 10 include a performance restriction module 110 and an event detector 112 as part of the instruction set included in the vehicle control system 100. In some embodiments, the fleet performance restriction system 300 is communicably connected to golf vehicles. In some embodiments, the fleet performance restriction system 300 is additionally or alternatively communicably connected to a general class of off-road machine or vehicle including lightweight or recreational machines or vehicles such as golf vehicles, ATVs, UTVs, snowmobiles, etc. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to some embodiments, the general configuration of the fleet performance restriction system 300 is configured to receive or acquire vehicle data (e.g., motion data) from a communicably connected vehicle within the fleet of vehicles 10 (e.g., vehicle A and vehicle B); to process the vehicle data to determine if any undesirable operations have occurred; to determine actions to mitigate similar future occurrences of undesirable operations of the vehicles 10 within the fleet; and to command the vehicles 10 within the fleet to take such actions if the fleet performance restriction system 300 determines that the need is great enough. In some embodiments, the fleet performance restriction system 300 is configured to receive or acquire vehicle data that includes occurrences of undesirable operations that were detected by the vehicles 10. The general configuration is described in more detail herein, according to some embodiments. In some embodiments, weather forecasts and/or current conditions can be used to determine there is a need to take an action to mitigate occurrences of undesirable operations preemptively (e.g., before any undesirable operations have occurred).

According to some embodiments, the performance restriction module 110 is configured to receive, from the fleet performance restriction system 300 via the communications interface 106, commands related to any of a number of actions (e.g., performance restrictions, alerts, etc.) that can be implemented by the vehicle 10 associated therewith (e.g., vehicle A or vehicle B) to mitigate undesirable operations. For example, the performance restriction module 110 may be configured to receive a command to reduce the maximum speed of the vehicle 10. In this example, the performance restriction module 110 may command the driveline 50 of the vehicle 10 to limit the speed to a specified maximum speed. In some embodiments, the performance restriction module 110 may have to perform calculations or processes to determine how to perform the performance restriction. For example, to limit the speed of the vehicle 10, the performance restriction module 110 may calculate, based on wheel size and gearing ratios in the driveline, a maximum number of rotations per minute of the prime mover 52 of the vehicle 10 for each gearing ratio. In some embodiments, the performance restriction module 110 may be able to receive commands for any number of performance restrictions or actions and cause implementation of the action in any of the vehicle subsystems, including the operator controls 40, the driveline 50, the suspension system 60, the braking system 70, and/or the sensors 90. Additional examples of commands for actions the performance restriction module 110 may receive and implement include, but are not limited to: produce an alarm or announcement via the operator interface 48; display a warning via the operator interface 48; reduce the maximum acceleration of the vehicle 10 via either driveline 50 or the operator controls 40; reduce the maximum power of the vehicle 10 via driveline 50; reduce the maximum torque of the vehicle 10 via driveline 50; change parameters within the braking system 70; change parameters within the suspension system 60 (e.g., pressurize dampers); change parameters within the control of the sensors 90 (e.g., how fast the sensors 90 sample).

According to some embodiments, the event detector 112 is configured to detect occurrences of undesirable operation of the vehicle 10. For example, the event detector 112 may use information from the sensors 90 to determine that the wheels are spinning slower than expected given the speed of the vehicle 10 and determine a skid event has occurred. As another example, the event detector 112 may use information from the sensors 90 to determine that the wheels are spinning faster than expected given the speed of the vehicle 10 and determine a loss of traction event has occurred. In some embodiments, the event detector 112 is configured to determine a magnitude of the occurrence of the event in addition to detecting the event. Additional examples of events that may be detected include, but are not limited to: wheel spin, excessive vehicle tilt, excessive vehicle vibrations, or one or more wheels leaving the driving surface. In some embodiments, after detecting an event, the event detector 112 is configured to communicate the occurrence of the event and/or information from the sensors 90 to the fleet performance restriction system 300 for further processing. In some embodiments, the vehicles 10 do not have an event detector 112 and all relevant sensor information may be communicated to the fleet performance restriction system 300 via the communications interface 106. In some embodiments, the event detector 112 is configured to identify the possibility of an event and send relevant sensor information to the fleet performance restriction system 300 via the communications interface 106 for further processing. Advantageously, if the vehicles 10 do implement some form of an event detector 112 and only send data for time periods proximate to the time the event was detected, communications traffic over the network 210 may be reduced.

As shown in FIG. 4, the fleet performance restriction system 300 includes a processing circuit 302, memory 304, and a communications interface 306. Memory 304 may include an event detector 308, a performance restriction determiner 310, a risk calculator 312, a risk evaluator 314, and a trajectory predictor 316. In some embodiments, any number of these features may be spread across the various memory devices within the on-site system 260, the off-site server 250, or a vehicle (e.g., vehicle A or vehicle B). For example, a vehicle may include the performance restriction determiner 310 and the off-site server 250 may include the risk calculator 312, the risk evaluator 314, and the trajectory predictor 316 (in this example the event detector 308 may not be necessary and the system could rely on the on-vehicle event detector 112). In some embodiments, the trajectory predictor 316 may be included in the vehicle control system 100. In some embodiments, all of the fleet performance restriction system 300 may be implemented as part of the vehicle control system 100.

According to some embodiments, the communications interface 306 of the fleet performance restriction system 300 is configured to receive signals communicating vehicle information from a first vehicle (e.g., vehicle A) and relay any of the vehicle information to any of the modules within the fleet performance restriction system 300. Vehicle information may include motion data (e.g., speed, acceleration, location, rpm, etc.) and the occurrence of any event (or possible event) detected by the event detector 112. The event detector 308, may be configured to use the vehicle information and perform additional processing. For example, the event detector 308 may be configured to detect additional events, or different types of events relative to the event detector 112. In some embodiments, the event detector 308 is configured to validate that an event detected by the event detector 112 did occur or the event detector 308 is configured to determine a magnitude of the event occurrence detected by the event detector 112. In some embodiments (e.g., those embodiments where the vehicles do not include an on-vehicle event detector 112), the event detector 308 is configured to perform all of the event detection. In some embodiments, the processing the event detector 308 performs is dependent on the vehicle from which the vehicle information is received. For example, an older generation vehicle may not include the event detector 112 or have a less sophisticated event detector and the vehicle information received from that vehicle may require additional processing.

According to some embodiments, the performance restriction determiner 310 is configured to determine an action or actions (e.g., performance restrictions) that would mitigate the risk of occurrence, or the severity of a subsequent event related to a detected event. For example, the performance restriction determiner 310 may receive an indication of an occurrence of skid from an event detector (e.g., the event detector 112 and/or the event detector 308) and determine that limiting the maximum speed of the vehicle would mitigate the probability of a reoccurrence and/or the severity of a reoccurrence. In some embodiments, more than one action can be determined to have a mitigating effect. In some embodiments, the performance restriction determiner 310 is configured to use vehicle data from a time period proximate to the time of the detected event. For example, the performance restriction determiner 310 may use vehicle data to determine that the speed of the vehicle prior to the skid was a first speed and determine that limiting the maximum speed of the vehicle to some fraction of the first speed may mitigate future occurrences. In some embodiments, performance restriction determiner 310 is configured with a mapping between an occurrence of undesirable operations or classes of such occurrences and actions or classes of actions in order to determine the action to command for a given occurrence. In some embodiments, the performance restriction determiner 310 is configured to learn what classes of actions are able to mitigate reoccurrences of the event classes. For example, the performance restriction determiner 310 may determine an action and, based on the severity or frequency of recurrence, learn that the determined action did not have the expected mitigation effect, and modify how it performs future determinations. The process of learning actions that mitigate recurrence of various event classes could be performed by any suitable method (e.g., reinforcement learning, etc.).

According to some embodiments, the risk calculator 312 is configured to calculate a value related to the need for a vehicle to take an action (e.g., implement a performance restriction, make an announcement, etc.) based on any of the previous occurrences of undesirable operations. In some embodiments, the calculation is dependent on a second vehicle for which an action is being considered. For example, the calculation may be based on the location of the second vehicle or the age of the second vehicle or any of the components thereof. In other embodiments, the calculation may be independent of the vehicle. For example, the risk calculator 312 could count the number of times an event occurred for which the performance restriction determiner 310 suggested the maximum acceleration of the vehicle be limited over a past time period or the risk calculator 312 could add the number of times a performance restriction was recommended modified by a factor related to the severity of the occurrence of the undesirable operations over a past time period. In some embodiments, the risk calculator 312 may be configured to maintain a value (e.g., one value for one vehicle or one value for every vehicle in the fleet) related to the need for a vehicle to take an action and periodically update that value. For example, the risk calculator 312 may increase the value each time an event of undesirable operation related to action occurs and decrease the value slowly over time (e.g., when no events occur). In some embodiments, the risk calculator 312 is configured to maintain a value for each combination of vehicle in the fleet and action that can be implemented (e.g., in a 2-dimensional array). For example, the risk calculator 312 may be configured to maintain elements of the array rᵢⱼ, related to the need for the i^{th} vehicle of the fleet to perform the j^{th} action and to, after the detection of an event, update the elements of the array. In some embodiments, after an event of undesirable performance occurs in vehicle p and the performance restriction determiner 310 determines that action q may mitigate future occurrences, the elements of the array may be updated for each vehicle by:

$${r}_{i q} = {r}_{i q} + f ( {δ}_{ip} , {a}_{i 1} , … , {a}_{ik} , … , {a}_{iK} , {d}_{i} , s , {t}_{od} )$$

where the update function ƒ is a multi-dimensional function that depends on distance, dip, between vehicle i and vehicle p, age of K components of vehicle i (aᵢ₁, . . . , aᵢₖ, . . . , a_{iK}), driver of the i^{th} vehicle, dᵢ, severity of the occurrence, s, and time of day t_{od}. In some embodiments, rᵢⱼ, may be periodically reduced by:

$${r}_{ij} = α {r}_{ij}$$

where α is a number between zero and one. In some embodiments, a itself may be a function of various factors including those on which ƒ depends. Additionally, variables on which the multidimensional function ƒ may depend include the model of the vehicle, an indication of a specific vehicle (e.g., a known problematic vehicle), driver statuses (e.g., VIP, erratic driver, etc.), driver age, season, fleet size or the currently operating fleet size, etc. In some embodiments, site-specific factors (e.g., the locations of consistent problem areas, times of increased traffic, times and/or directions of motion wherein the sun angle may increase risk, etc.) may be learned, for example, by the fleet performance restriction system 300, and/or entered by a site manager to affect the update function for otherwise affect how risk calculator 312 calculates the value related to the need for a vehicle to take an action. It is noted that the equations presented are only examples as to how the risk calculator 312 may calculate the value related to the need for another vehicle to take an action. The examples are not meant to be limiting in form or in the variables on which the function depends.

According to some embodiments, the risk calculator 312 is configured to maintain a multi-dimensional function for a number of vehicles that may depend on at least a location of the vehicle. For example, a function gᵢⱼ may be maintained to represent the need for the i^{th} vehicle to perform the j^{th} action and the function may, among a number of other dependencies, depend on a geographic East-West dimension and a geographic North-South dimension as shown in:

$${g}_{ij} ( {x}_{i} , {y}_{i} , {a}_{i 1} , … , {a}_{ik} , … , {a}_{iK} , {d}_{i} , s , {t}_{od} ) ,$$

where xᵢ represents the East-West location and y; represents the North-South location. In some embodiments, the risk calculator 312 may be configured to update the multi-dimensional function after an event of undesirable performance occurs in vehicle p and the performance restriction determiner 310 determines that action q may mitigate future occurrences. For example, the function may be updated by:

$${g}_{iq} = {g}_{iq} + exp \{ - {( [ \begin{matrix}{x}_{i} \\ {y}_{i}\end{matrix} ] - [ \begin{matrix}{x}_{p , k} \\ {y}_{p , k}\end{matrix} ] )}^{T} ( [ \begin{matrix}{x}_{i} \\ {y}_{i}\end{matrix} ] - [ \begin{matrix}{x}_{p , k} \\ {y}_{p , k}\end{matrix} ] ) \} ,$$

where x_{p,k} and y_{p,k} define the location of the vehicle p when the occurrence of the undesirable operations occurred. In some embodiments, the risk calculator 312 may be configured to maintain a sampling of a multi-dimensional function rather than the multi-dimensional function itself. For example, the outputs of the multi-dimensional function may be saved for a regular grid within the multi-dimensional space and the values making up the rectangular grid could be updated by sampling the update function (e.g., as defined previously) on the same grid. In some embodiments, when the value related to the need to perform an action must be calculated interpolation may be used along with the values sampled from the function. In some embodiments, the multi-dimensional function may be periodically reduced by multiplying it or its outputs sampled on a rectangular grid by a number between zero and one (this number itself potentially having various dependencies).

In some embodiments, the risk calculator 312 includes a reset mechanism to reduce or set to zero the value (or function thereof) related to the need for a vehicle to take an action. The reset may be initiated by managing personnel (e.g., using the remote systems 240). For example, a reset could be initiated when the circumstances (e.g., event, condition, etc.) that caused the undesirable operations or risk thereof have passed. The value may be reset daily (e.g., be setting the value to zero at a certain time each day), the value may be reset by decreasing the value periodically, or the value may be reset by decreasing the value using a formulaic approach as described herein.

In some embodiments, the risk calculator 312 is configured to calculate the value related to the need for a vehicle to take an action dependent on a weather forecast and/or current weather conditions (e.g., received by the remote system 240). A poor weather forecast (e.g., rain, snow, frost, etc.) may cause an adjustment to the value (e.g., by an additive amount) or an increase to the sensitivity of the value to occurrences of undesirable operations that are detected (e.g., by multiplying the increase in the value by a factor). For example, snow in the forecast may add a constant offset to a value related to the need to decrease the maximum speed of a vehicle advantageously allowing the system to react after fewer occurrences of skid or wheel spin are detected. Any adverse weather condition in the forecast may affect or cause an adjustment to the operations of the risk calculator 312. For example, rain, sleet, freezing rain, snow, hail, frost, dew, etc. indicated by the weather forecast could cause an increase in the value related to the need for a vehicle to take an action or otherwise affect the calculations in the risk calculator 312 and/or the risk evaluator 314. In some embodiments, the weather forecast may be significant (e.g., to cause a large constant offset to be added to the value related to the need for a vehicle to take an action) and action may be taken before any undesirable operations occur. In some embodiments, a calendar event (e.g., a tournament weekend or any other event that may result in increased golf vehicle traffic) may cause similar adjustments to the operations of the risk calculator 312 and/or the risk determiner 314.

Referring to FIGS. 5-7, the manner by which a multi-dimensional function of location may be used to update values related to the need for a vehicle to take an action will become more clear through a detailed explanation according to some embodiments. FIG. 5 shows a map 340 containing a portion of the geographic area the fleet of vehicles operate within. According to some embodiments, a value related to a need for a vehicle to implement a mitigating action may be saved for various locations (e.g., location 344) on a regular grid (e.g., grid 342). In some embodiments, these values may be independent of vehicle and only one grid of such values stored for all vehicles. In some embodiments, these values may depend on multiple factors of the vehicle (e.g., age of the vehicle or age of a component of the vehicle) and values may be stored for various location for each vehicle or groups of similar vehicles. In some embodiments, the numbers may only be saved if they are non-zero or significantly different than zero as to avoid overburdening memory by saving the number zero for numerous locations. According to some embodiments, when the risk calculator 312 needs to calculate the value related to the need to perform an action at a specific location, the risk calculator 312 may perform interpolation using the saved values or a portion of the saved values. For example, nearest-neighbor interpolation, spline interpolation, or any form of fitting a function with a portion of the data points and then evaluating the fit function may be used to perform the interpolation.

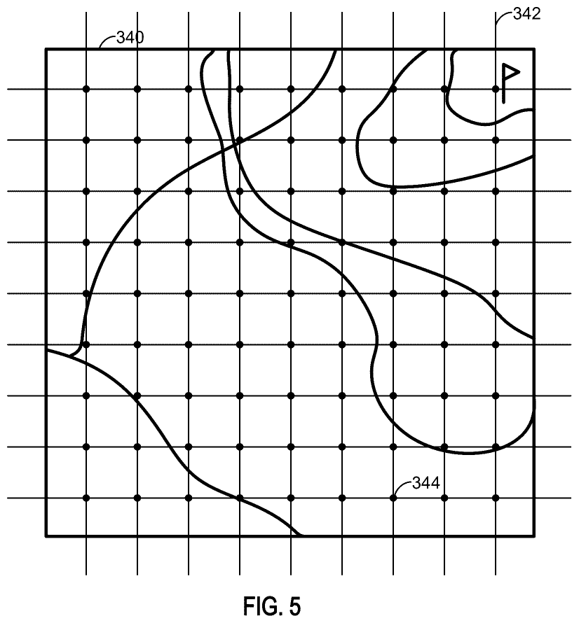

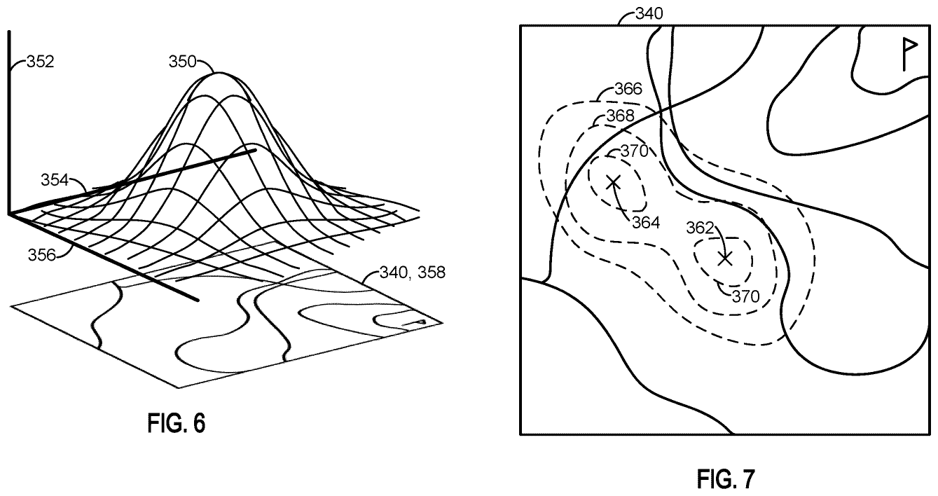

FIG. 6 shows an example of an update function that may be used to update a multi-dimensional function used by the risk calculator 312. According to some embodiments, an update function 350 is shown to depend on an East-West dimension 356 and a North-South dimension 354. The output of the update function is shown to exist in the dimension 352 of the value related to the need to perform an action. This may be overlaid on a map 358 of the vicinity of the occurrence of the undesirable operation. In some embodiments, the update function 350 is evaluated and the results are used to update a multi-dimensional function related to the need for a vehicle to perform an action. In some embodiments, the output of the multi-dimensional function may be initialized to zero for all locations (in all other dimensions, e.g., dimensions related to the age of components of the vehicle, etc.) and after an occurrence the multi-dimensional function is updated according to the update function. For example, after initialization, an occurrence of the undesirable operations may happen near the center of the map 358; multi-dimensional update function may be evaluated for the other vehicles of the fleet for locations near the occurrence of the undesirable operations on a regular grid in the space of the multi-dimensional function; and the results of the evaluations may be added to the initialized values on the same regular grid. In some embodiments, the multi-dimensional update function 350 may depend on vehicle age or the age of any of the components of the vehicle. In such embodiments, it may be difficult to visualize the update function, but its projection onto the three-dimensional space of FIG. 6 may be similar to the update function 350 (for example, with the height of the function dependent on the vehicle for which it was sampled).

Referring now to FIG. 7, over time additional occurrences of undesirable operation may occur. After each occurrence, the update function shown in FIG. 6, (but shifted to be centered at the location of the occurrence) may be added to the current function related to the need for a vehicle to take an action. For example, undesirable operation may occur at location 364 in one vehicle and at location 362 in another vehicle. According to some embodiments, after the update occurs for two such events, the multi-dimensional function (or its stored outputs on a regular grid) may look as indicated by the contour lines (e.g., the contour lines 366-370) in FIG. 7. Each contour line indicates locations for which the value calculated by the multi-dimensional function is the same, the values calculated on the contour line 370 being greater than those on the contour line 368.

Referring to FIG. 4, the risk evaluator 314 may be configured to use the results of the risk calculator 312 to determine if an action (e.g., a performance restriction, notification, etc.) should be sent to any vehicles for implementation by the performance restriction module 110. For example, the risk evaluator 314 may be configured to compare the calculations performed by the risk calculator 312 to a threshold and decide whether the fleet performance restriction system 300 should send a command to implement the action to each vehicle for which the calculated value related to the need for a vehicle to take an action is greater than a threshold value. In some embodiments, the risk evaluator 314 may be configured to determine a set of points (e.g., locations) for which the value calculated by the risk calculator 312 are equal to the threshold. This set of points may be indicative of a boundary within which a vehicle would be subjected to an action. It is noted that it is mathematically equivalent to have the value calculated by a risk calculator (e.g., the risk calculator 312) depend on a set of variables, to have the threshold depend on the same set of variables, or to have both the value calculated by the risk calculator and the threshold depend on the same set of variables. Any dependency the threshold has on the variables could be moved to into the value calculated by the risk calculator and the resultant risk calculation comparted to a constant threshold. For example, consider a multi-dimensional function defining the value calculated by a risk calculator,

$${g}_{ij} ( {x}_{i} , {y}_{i} , {a}_{i 1} , … , {a}_{ik} , … , {a}_{iK} , {d}_{i} , s , {t}_{od} ) .$$

and a multi-dimensional threshold function,

$$h ( {x}_{i} , {y}_{i} , {a}_{i 1} , … , {a}_{ik} , … , {a}_{iK} , {d}_{i} , s , {t}_{od} ) .$$

Deciding to send an action when gᵢⱼ>h is the same as deciding to send an action when

$${g}_{ι j}^{′} > 0$$

where

$${g}_{ι j}^{′} = {g}_{ij} - h .$$

The significance or impact of the action may depend on the result of the calculations performed by the risk calculator 312 or the result of the comparisons of the risk evaluator 314. In some embodiments, the risk calculator 312 is configured to perform separate calculations for actions of different significances or impacts. For example, the risk calculator 312 may calculate a value related to the need for a vehicle to limit its speed to a first speed and calculate a value related to the need for the vehicle to limit its speed to a second lower speed. In some embodiments, the risk calculator 312 may perform one calculation for a family of actions and the significance of any action taken may depend on how the result of the calculation compares to the threshold. For example, the risk evaluator 314 may be configured to determine an alert to possible adverse conditions should be sent if the threshold is exceeded; determine that speeds should be limited to a first speed if the threshold is exceeded by a first amount; and determine that speed should be limited to a second, lower speed if the threshold is exceeded by a second higher amount. The significance or impact of the action may depend on the extent by which the threshold is exceeded. For example, the speed limit may be a continuous function of the difference between the value related to the need for a vehicle to limit its speed and the threshold. In some embodiments, a general function that maps (i) the value related to the need for a vehicle to take an action and (ii) the threshold to a significance or impact of the action may be used. The general function may be stepwise, continuous, linear, non-linear, depend on the value and the threshold independently of each other, depend on the difference of the value and threshold, or include any other suitable forms.

According to some embodiments, the results of any calculations performed by the risk calculator 312 or determinations by the risk evaluator 314 are communicated via the communications interface 306 to a vehicle (e.g., vehicle A) or to a user device (e.g., user device A1 232a). In some embodiments, the results of the calculations (or determinations or comparisons) may be overlaid on a map. For example, the values related to the need for a vehicle to take an action could be overlaid on a map comprising locations proximate to current location of the vehicle in a contour plot similar to that shown in FIG. 7 and displayed on the operator interface 48 or on a display of any user device 232. The map may alert the operator to the potential of an upcoming hazard even if no performance restriction or further notification is generated. According to some embodiments, the results of any calculations performed by the risk calculator 312 or determinations or comparisons by the risk evaluator 314 are communicated to other systems of the remote systems 240. For example, the on-site system 260 may include a display to communicate status to a manager responsible for managing the fleet of vehicles or the area within which they operate; the value related to the need for a vehicle to take an action may be displayed; and if the value is large in a certain area the manager may decide to investigate the cause of the undesirable operations.

Referring to FIG. 4, the trajectory predictor 316 may use information from the sensors 90 of a vehicle to determine probable future locations for that vehicle. For example, the trajectory predictor 316 may use location from a GPS, orientation from an on-board compass, and speed from a speedometer to determine probable future locations in front of the vehicle by an amount proportional to the speed of the vehicle. According to some embodiments, actions may be communicated to vehicles and implemented based on the calculation of the value related to the need to take an action at a future location exceeding the threshold. For example, an action related to a future location may include an alert to the adverse conditions or upcoming performance restriction (e.g., announcing “You are approaching an area under a performance restriction”); or include ramping up the performance restriction as the vehicle approaches the area where the threshold would be exceeded.

Still referring to FIG. 4, the fleet performance restriction system 300 may be communicably connected to a number of user devices (e.g., the user devices 232 a-c). The user devices 232 may be associated with a vehicle. For example, the user device 232 A1 may be owned by a current registered operator of the vehicle 10a and associated with that vehicle. In some embodiments, the fleet performance restriction system 300 is configured to receive measurements from sensors components of the user devices 232 to expand the available vehicle data for event detection and/or determining if an action should be taken. In some embodiments, the fleet performance restriction system 300 is configured to send information to the user devices 232 as performance of an action in response to undesirable operations. Information sent to user devices may include: an alert of a performance restriction, a notification of a previous occurrences of undesirable operation, data to produce a map showing the locations undesirable operations occurred, boundaries within which performance restrictions are active, etc. For example, vehicle A may detect an occurrence of slip; the performance restriction determiner 310 may determine a suitable action to mitigate recurrence is to limit the acceleration of vehicles; given the proximity of vehicle B to the location of the occurrence of slip, the risk calculator 312 may determine a moderate chance of recurrence for vehicle B; and the risk evaluator 314 may recommend maximum acceleration/speed to be reduced by 20%. Given this sequence of events the fleet performance restriction system 300 may be configured to send a command to implement the performance restriction to vehicle B (and any other vehicles for which risk evaluator recommended the restriction). Additionally, in this example, the fleet performance restriction system 300 may also be configured to send a text message (e.g., via short messaging service (SMS)) to user device B1 indicating the performance restriction.

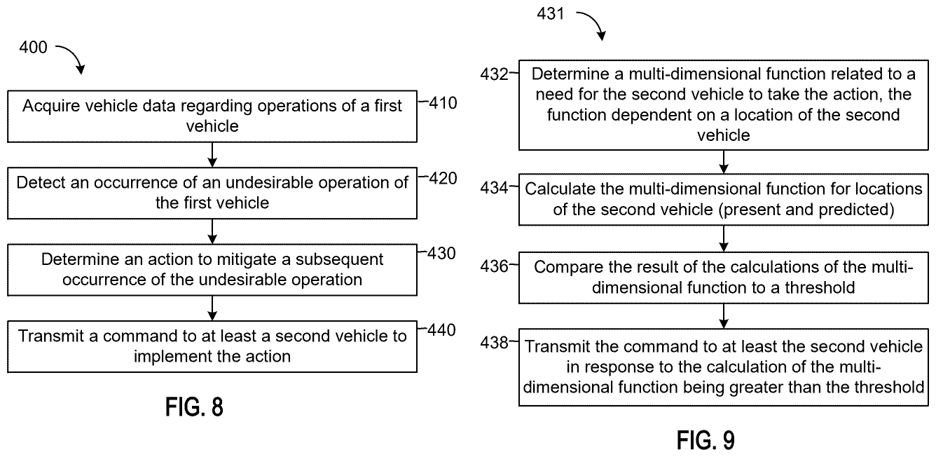

FIGS. 8 and 9 show flow diagrams for processes 400 and 431 implementing methods for mitigating the recurrence of undesirable operations in a fleet of vehicles according to some embodiments. The processes shown in FIGS. 8 and 9 may be implemented by a system configured to mitigate the recurrence of undesirable operations within a fleet of vehicles (e.g., the fleet performance restriction system 300). The processes 400 and 431 could be performed by a number of processors distributed across a number of devices (e.g., vehicles within a fleet, an off-site server system, an on-site server system, etc.) using a number of communication interfaces and a number of communications networks to send various results of intermediate steps within the process to different processors as needed.

According to some embodiments, the process 400 is a method for mitigating the recurrence of undesirable operations within a fleet of vehicles. According to some embodiments, the process 400 begins with acquiring vehicle data regarding the operations of a first vehicle in a step 410. Vehicle information may include motion data (e.g., speed, acceleration, location, rpm, etc.), information regarding a driver of the vehicle, vehicle age or the age of any component thereof, or any other information pertinent to the detection and analysis of undesirable operations. According to some embodiments, the process 400 includes a step 420 to detect an occurrence of an undesirable operations of the first vehicle. For example, the vehicle data regarding vehicle operations may be used to determine that the wheels are spinning slower than expected given the speed of the vehicle and determine a skid event has occurred. In some embodiments, a magnitude of the occurrence may be determined in addition to detecting the event. For example, the length of time the skid lasted, the distance traveled during the skid event, or the difference in the wheel speed and the implied wheel speed from the speed of the vehicle may be determined. Additional examples of events that may be detected include, but are not limited to: wheel spin, excessive vehicle tilt, excessive vehicle vibrations, or one or more wheels leaving the driving surface.

In some embodiments, the process 400 includes a step 430 to determine an action that could mitigate (e.g., reduce the severity, reduce the probability, etc.) a subsequent occurrence of the undesirable operation. For example, after the step 420 determines that a skid has occurred, the step 430 may determine that limiting the maximum speed of the vehicle would mitigate the probability of a reoccurrence and the severity of a reoccurrence. In some embodiments, the step 430 includes using vehicle data from a time period proximate to the time of the detected event. For example, vehicle data may be used to determine that the speed of the vehicle prior to the skid was a certain speed and determine that limiting the maximum speed of the vehicle to some fraction of the certain speed may mitigate future occurrences. In some embodiments, performance of the step 430 may use a mapping between classes of events and classes of actions (e.g., performance restrictions, alerts, etc.) in order to determine an appropriate action for a given occurrence of undesirable operations. In some embodiments, the step 430 includes a learning subprocess to learn what classes of actions are able to mitigate reoccurrences of the event classes. For example, a performance restriction may be determined based on the severity or frequency of recurrence. In this example, the determined performance restriction may not have had the expected mitigation effect, and the learning subprocess may learn to use other actions for similar undesirable operations. The learning subprocess may be performed by any suitable method (e.g., reinforcement learning, etc.). In some embodiments, more than one action may be determined to have a mitigating effect.

According to some embodiments, after an action has been determined the process 400 includes a step 440 to transmit a command to a number of vehicles to implement the action. In some embodiments, the command may be transmitted to all vehicles of the fleet after a suitable action has been determined. In some embodiments, the command may be transmitted to a subset of the vehicles of the fleet based on a criterion or a set of criteria. For example, after the occurrence of a skid event, a command to limit the maximum speed may be sent to all vehicles of the fleet that have tires older than the tires of the vehicle that experienced the skid. In some embodiments, more than one action may be determined to have a mitigating effect in the step 430. In some embodiments, a first set of the determined actions is sent to a first set of vehicles of the fleet and a second set of the determined actions is sent to a second set of vehicles of the fleet. In some embodiments, the command does not have to be transmitted to the vehicles directly after determining a mitigating action, nor does the command have to be sent to all vehicles that may eventually get the command at approximately the same time. For example, a criterion for the command to be sent to a vehicle may be the vehicle must be within a certain distance from the location of the occurrence of the event. In such an example, the action and the criterion may be stored and transmitted to any vehicle that enters the geographic area defined by the criterion (e.g., enters a geofence associate with the action).

In some embodiments, determining if a command to implement an action should be sent to a vehicle may include calculating a value related to the need for a second vehicle to take the action as described in the process 431. In some embodiments, the process 431 begins by determining a multi-dimensional function that when evaluated produces a result related to a need for the second vehicle to take the action. In some embodiments, the multi-dimensional function depends on location as shown in a step 432. Example multi-dimensional functions may include those described above as possible calculations performed by some embodiments of the risk calculator 312. For example, the multi-dimensional function may depend on many factors. For example, the calculation may be based on the location of the second vehicle; the count of occurrences of the undesirable operation over a previous time period; an amount of time since the most recent occurrence of the undesirable operations across the vehicles of the fleet; the severity of any of the occurrences of the undesirable operations; the age of the second vehicle or any components thereof; a current time of day; a driver of the second vehicle, etc. The multi-dimensional function may be evaluated for several hypothetical locations of the second vehicle to produce results related to the need for the second vehicle to take the action at the hypothetical locations. The results of these evaluations may, for example, be overlaid on a map and displayed for a site manager or the operator of the vehicle to view. In some embodiments, the process 431 includes a step 434 to evaluate the multi-dimensional function for the current location of the vehicle and predicted locations of the vehicle (e.g., projecting possible locations of the vehicle in the near term based on current speed, heading, and trails the vehicle is on). In some embodiments, the process 431 includes a step 436 to compare the results of the evaluations to a threshold. The threshold may be a constant value, or it may also be a function of the same variables as the multi-dimensional function. As stated in the proceeding sections, under many scenarios comparing to a constant threshold and comparing to a threshold that depends on the variables the multi-dimensional function are mathematically equivalent. In some embodiments, the process 431 includes a step 438 to transmit the command in response to a number of the results of the evaluations being greater than the threshold.

Several of the examples described herein have used location of the vehicle 10 as a variable on which the value related to the need for a vehicle to take an action depends. It is noted that while location of the vehicle 10 may be used in the calculations of the risk calculator 312 and the risk evaluator 314, it is not a required variable. For example, if several vehicles experience undesirable operations and/or the weather forecast is adverse, the risk calculator 312, may determine a need to take action great enough that all vehicles receive a performance restriction independent of location.

As stated herein, the significance or impact of the action may depend on the extent by which the threshold is exceeded. Two actions may be specified, one action taken when the threshold is violated and a second (e.g., more severe or significant, different, etc.) action may be taken when the threshold is violated by a second amount (which may be equivalent to having two thresholds). In some embodiments, the significance of the action is a continuous function of the amount by which the threshold is violated. For example, a maximum speed restriction may be a continuous function of the difference between the value related to the need for a vehicle to limit its speed and the threshold. In some embodiments, a general function that maps (i) the value related to the need for a vehicle to take and action and (ii) the threshold to a significance or impact of the action may be used. The general function may be stepwise, continuous, linear, non-linear, depend on the value and the threshold independently of each other, depend on the difference of the value and threshold, or include any other suitable forms.

In some embodiments, the calculations are independent of the vehicle. For example, the number of times an event occurred for which particular action was determined could be counted and compared to the threshold. In some embodiments, the value related to the need for a vehicle to perform a restriction is updated as events occur and decreased over time (e.g., using a reset mechanism or formulaic approach as described previously). In some embodiments the amount of the increase is modified by a number of factors (e.g., the severity of the occurrence or motion data describing the circumstances of the event). In some embodiments, a value is maintained for each combination of vehicle in the fleet. In some embodiments, the outputs of the multi-dimensional function are saved on a regular grid within the multi-dimensional space and the values making up the rectangular grid could be updated by sampling an update function (e.g., as defined previously) on the same grid. In some embodiments, when the value related to the need to perform an action must be calculated interpolation may be used along with the values sampled from the function. In some embodiments, the multi-dimensional function is periodically reduced by multiplying it or its outputs sampled on a rectangular grid by a number between zero and one.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.), the site monitoring and control system 200 (e.g., the remote systems 240, the user portal 230, the user sensors 220, etc.), and the fleet performance restriction system 300 as shown in the various exemplary embodiments is illustrative only. Additionally, any element disclosed in one embodiment may be incorporated or utilized with any other embodiment disclosed herein.

1. A golf vehicle fleet system for responding to undesirable operations within a fleet of golf vehicles, the golf vehicle fleet system comprising:
one or more memory devices having instructions stored thereon that, when executed by one or more processors, cause the one or more processors to:
detect a risk of an undesirable operation of a golf vehicle of a plurality of golf vehicles of the fleet of golf vehicles; and
transmit a command to at least the golf vehicle of the fleet of golf vehicles to implement an action to mitigate a future occurrence of the undesirable operation with the golf vehicle.

2. The golf vehicle fleet system of claim 1, wherein detecting the risk of the undesirable operation comprises at least one of:
acquiring an adverse weather forecast; or
acquiring information related to an event with potential for increased golf vehicle traffic.

3. The golf vehicle fleet system of claim 1, wherein detecting the risk of the undesirable operation comprises:
acquiring vehicle data regarding a second golf vehicle of the plurality of golf vehicles of the fleet of golf vehicles; and
detecting an occurrence of the undesirable operation of the second golf vehicle of the plurality of golf vehicles.

4. The golf vehicle fleet system of claim 3, wherein the action is based on a type of the undesirable operation and the vehicle data and, wherein the undesirable operation includes at least one of wheel spin, skid, or one or more wheels leaving a driving surface.

5. The golf vehicle fleet system of claim 3, wherein a magnitude of the action is determined based on a severity of the undesirable operation.

6. The golf vehicle fleet system of claim 3, wherein the action includes at least one of:
indicating the occurrence on an operator interface of the golf vehicle or a user device associated with the golf vehicle;
restricting an acceleration of the golf vehicle;
restricting a torque produced by a driveline of the golf vehicle;
restricting a power produced by the driveline of the golf vehicle; or
restricting a maximum speed of the golf vehicle.

7. The golf vehicle fleet system of claim 3, wherein the instructions cause the one or more processors to calculate a value related to a need for the golf vehicle to take the action, and wherein the command is transmitted to the golf vehicle in response to a comparison between the value and a threshold value.

8. The golf vehicle fleet system of claim 7, wherein the value is based on at least one of:
a first location of the golf vehicle relative to a second location of the occurrence of the undesirable operation;
a count of occurrences of the undesirable operation of the plurality of golf vehicles of the fleet within a previous time period;
an amount of time since a most recent occurrence of the undesirable operation of any of the plurality of golf vehicles;
a severity of the most recent occurrence of the undesirable operation;
an age of at least one of the golf vehicle or one or more components thereof;
a current time of day relative to a time at which the undesirable operation of the second golf vehicle occurred; or
a driver of the golf vehicle.

9. The golf vehicle fleet system of claim 8, wherein the value is based on the first location of the golf vehicle relative to the second location, wherein the value is calculated for several locations proximate the second location.

10. The golf vehicle fleet system of claim 8, wherein the value is calculated using a multi-dimensional function based on (a) the first location of the golf vehicle and (b) at least one of the count of occurrences of the undesirable operation, the amount of time since the most recent occurrence of the undesirable operation, the severity of the most recent occurrence of the undesirable operation, the age of at least one of the golf vehicle or the one or more components thereof, the current time of day relative to the time at which the undesirable operation of the second golf vehicle occurred, or the driver of the golf vehicle.

11. The golf vehicle fleet system of claim 10, wherein, after the occurrence of the undesirable operation, the value is increased by a second multi-dimensional function of the first location, the second multi-dimensional function based on a distance between the first location and the second location.

12. The golf vehicle fleet system of claim 7, wherein a magnitude of the action is dependent on a difference between the value and the threshold value.

13. The golf vehicle fleet system of claim 7, wherein the value is based on a first location of the golf vehicle, wherein a plurality of values is calculated for various potential first locations, wherein the value for actual first locations is found via interpolation using the plurality of values.

14. The golf vehicle fleet system of claim 7, wherein the value is increased after each detection of the undesirable operations and decreased using at least one of:
a reset mechanism;
periodically decreasing the value over time by an amount; or
periodically decreasing the value by multiplying the value by a fraction between zero and one.

15. The golf vehicle fleet system of claim 3, wherein the instructions cause the one or more processors to acquire the vehicle data from at least one of the second golf vehicle or a global positioning system.

16. An off-road vehicle fleet system for responding to undesirable operations within a fleet of off-road vehicles, the fleet of off-road vehicles including a first off-road vehicle configured to transmit vehicle data about operations thereof and a second off-road vehicle configured to receive commands to mitigate the undesirable operations, the off-road vehicle fleet system comprising:
a non-transitory computer-readable medium having instructions stored thereon that, when executed by one or more processors, cause the one or more processors to:
acquire the vehicle data regarding the first off-road vehicle;
detect an occurrence of an undesirable operation of the first off-road vehicle;
calculate a value related to a need for the second off-road vehicle to take an action to mitigate a subsequent occurrence of the undesirable operation; and
transmit a command to the second off-road vehicle to implement the action to mitigate the subsequent occurrence of the undesirable operation in response to the value satisfying a criterion;
wherein the value is calculated using a multi-dimensional function of at least a first location of the second off-road vehicle relative to a second location of the occurrence of the undesirable operation.

17. The off-road vehicle fleet system of claim 16, wherein the value is calculated using the multi-dimensional function based on (a) the first location of the second off-road vehicle and (b) at least one of a count of occurrences of the undesirable operation, an amount of time since a most recent occurrence of the undesirable operation, a severity of the most recent occurrence of the undesirable operation, an age of at least one of the second off-road vehicle or one or more components thereof, a current time of day relative to a time at which the undesirable operation of the first off-road vehicle occurred, or a driver of the second off-road vehicle.

18. The off-road vehicle fleet system of claim 16, wherein, after the occurrence of the undesirable operation, the value is increased by a second multi-dimensional function of the first location, the second multi-dimensional function based on a distance between the first location and the second location.

19. A golf vehicle fleet system for responding to undesirable operations within a fleet of golf vehicles, the golf vehicle fleet system comprising:
a non-transitory computer-readable medium having instructions stored thereon that, when executed by one or more processors, cause the one or more processors to:
acquire vehicle data regarding a first golf vehicle of a plurality of golf vehicles of the fleet of golf vehicles;
detect an occurrence of an undesirable operation of the first golf vehicle of the plurality of golf vehicles; and
cause a second golf vehicle of the fleet of golf vehicles to implement an action to mitigate a subsequent occurrence of the undesirable operation with the second golf vehicle when the second golf vehicle is proximate a location where the undesirable operation occurred.

20. The golf vehicle fleet system of claim 19, wherein a magnitude of the action depends on a severity of the undesirable operation.
